(19) United States
(12) Patent Application Publication
(10) Pub. No.: US 2026/0066698 A1
(43) Pub. Date: Mar. 5, 2026

(54) VOLTAGE CONTROL DEVICE, METHOD FOR DETERMINING THE OPTIMIZED MULTI-MEASUREMENT OPERATING POINT WITH CAPABILITY FOR ARTIFICIAL INTELLIGENCE AND VOLTAGE CONTROL SYSTEM IN BRANCHED NETWORK FOR VOLTAGE REGULATORS

(71) Applicant: TRANSFORMADORES E SERVIÇOS DE ENERGIA DAS AMÉRICAS S.A., Contagem (BR)

(72) Inventor: Felipe Vilaça MARCHEZINI, Contagem (BR)

(21) Appl. No.: 19/314,894

(22) Filed: Aug. 29, 2025

(30) Foreign Application Priority Data
Sep. 2, 2024 (BR) 102024018047-0

(51) Int. Cl. H02J 13/00; H02J 3/12

(52) U.S. Cl. CPC H02J 13/12; H02J 3/12; H02J 13/1335; H02J 13/333; H02J 13/34; H02J 2103/30; H02J 2103/35

(57) ABSTRACT

A voltage controller device, a method for determining the optimized operating point and a voltage control system for branched electrical energy distribution networks including voltage meters installed at the points where it is of interest to control the voltage, internally having communication in the LPWA standard. An LPWA modem collects this information and passes it on to the Branched Network Voltage Controller, which internally has the specialist algorithm for the calculation of the Tap that must be selected in the Voltage Regulator so that the voltages at all points of interest are as much as possible within the specified limits. For this, it sends a command to the Voltage Regulator controller in the form of a voltage at the input of the TP, being compatible with the legacy in the field, or in the form of a command in an application protocol for compatible Voltage Regulator controllers.

### FIELD OF THE INVENTION

The present invention consists of a voltage controller device, a method for determining the optimized operating point and a voltage control system for branched electrical power distribution networks comprising voltage meters installed at the points where it is of interest to control the voltage, internally having communication in the LPWA standard.

The system has its central control made by the Branched Network Voltage Controller connected to the Controller of the Voltage Regulator. It receives the communication data in the LPWA standard, collected from the field sensors installed in the distribution branches. It runs the control algorithm on its internal processor and delivers to the Controller of the Voltage Regulator a voltage or a control command. This voltage or command is determined by the internal algorithm so that, with this information, the regulator adjusts its tap and, consequently, the voltage at its output, so that all legs have the voltage as close as possible to the specified limits.

### BACKGROUND

The application of single-phase voltage regulator transformers in electrical power distribution systems, such as described in U.S. Pat. No. 2,677,810A, arose from the need to improve the quality of energy supply. As they are used to replace three-phase regulators, they aim to keep the voltage on load in distribution lines at strategic points or in substations regulated. The voltage regulating transformer is basically an autotransformer with the ability to increase or decrease the voltage of the system through the exchange of the physical connection (tap) between the windings, an exchange that is performed through an on-load tap changer. The automatic voltage regulation operation is performed through the use of microprocessed electronic controls, such as described in U.S. Pat. No. 4,419,619 A, which provide features of parameterization, data acquisition, analysis and control of the output voltage of the system. The electronic control for a single-phase voltage regulator aims to keep the electrical voltage in the network within predetermined limits by constantly monitoring the line parameters and triggering the on-load tap changer.

The electric power distribution system was originally designed considering a linear feeder, going from the substation, where the energy source is, to the load, where the energy consumption occurs, through a medium voltage distribution line. Longer distribution lines or with larger loads at their end require a Voltage Regulator at some point so that the voltage supplied is within the limits allowed by the guidelines, since the distribution line itself with its intrinsic impedance causes voltage drops dependent on the load current. The Voltage Regulator changes its Taps according to the commands of its control in order to achieve this goal. Over time, the topology of the energy distribution network became more complex and instead of being linear, going simply from the source in the substation to the load, it began to branch from the source to several loads, simply by adding legs over time. However, often only one voltage regulator equipment continued to be used on this feeder, so the voltage at some loads may be out of range.

Another novelty in the energy distribution system, which was not present in its initial design, is the DER, or distributed energy resources. Usually they make it impossible to use the traditional Line Drop Compensation (LDC) mechanism to determine the voltage in unbranched distribution lines due to the unpredictability and dynamic characteristic of the DER. For example, changes in solar intensity, wind speed or dispatch of energy from batteries, which are almost always not under the control of the energy distributor. In the branched topology this calculation is not usually possible due to the absence of the complete circuit model, even considering that the reading of the injected power could be available in near real time through communication.

FIG. 1 presents a hypothetical diagram of the branched electrical power distribution network. A voltage regulator bank can feed a branched network with energy distribution lines with different distances to the loads. Some of these loads may be associated with DER (Distributed Energy Resource) or this distributed energy resource may be on a branch at some point in the distribution line.

The scenario can be even more generalized, as presented in FIG. 2, with loads on both sides of the Voltage Regulator, including the side that comes from Substation SE1. Sometimes a second substation on the other side of the Voltage Regulator can also be connected through maneuvers in the distribution network. This can happen during self-healing maneuvers during lapses or in regions with the grid or ring distribution network. In these scenarios, the so-called strong side and weak side (referring to the side of the Substation or DER of smaller or larger short-circuit capacity) of the Voltage Regulator are confused and the Tap changes traditionally made may have the opposite effect than expected.

Communication with the points to have their voltage measured and controlled in the various branches of the electrical power distribution network can be done using LPWA networks, preferably the Wi-SUN standard, using the LPWA Radio Modem. Energy distribution networks are usually very long, longer than the standard reach of these radio systems, so Repeaters on the LPWA network may be required. Wi-SUN is a suitable system for this, as it has the ability to form mesh networks. At the points to have their voltage controlled, Voltage or Energy Meters with internal LPWA Transponders are installed.

LPWA networks are restricted resource networks, which can take several seconds to deliver the collected data to the Branched Network Voltage Controller, up to tens of seconds. However, this restriction is acceptable for the purpose of the present invention, as the time interval for monitoring the voltage of the distribution network is 10 minutes, according to ANEEL guidelines.

Aneel guidelines determine that the voltage supplied must be within the limits of a Reference Voltage (TR) plus the upper and lower variations accepted for the adequate voltage range (Δ_{ADSUP} and Δ_{ADINF}), as shown in FIGS. 3A-3B. Outside this range, the voltage will fall into the precarious voltage range, which goes up to the limits determined by the upper and lower precarious voltage variation (Δ_{PRSUP} and Δ_{PRINF}). Beyond these limits is the critical voltage range.

Document BR 112021014850-7 discloses techniques for calculating the tap position of a changer for a voltage regulator that basically consist of measuring the input and output voltages and currents and the impedances of the internal windings and calculating the Tap that must be triggered for the output to present the adequate voltage. This technique also allows to track the connected Tap without the need for additional hardware. However, it has no basic LDC functions described.

Document BR 102015003367-2 aims to describe a local control for voltage regulator based on line voltage drop compensation, reference voltage and insensitivity. However, it contemplates the control only of simple distribution lines, without a multi-measurement system.

U.S. Pat. No. 9,377,803 consists of an equipment that measures the voltage at certain points, detects the impedance and calculates the reactive power to be injected by one or several power regulation equipment, in order to further minimize losses in the distribution. It is aimed at the application of controlling the voltage for the case of high penetration of distributed generation, that is, the main objective is to limit the overvoltage caused by the injection of power by them. However, to perform this function, it needs to communicate to send commands to each DER and have access to the topology and circuit state database at the operation center of the distribution to calculate the reactive powers to be injected. In addition, the control is not done exclusively using a voltage regulating transformer, although it may be present.

Document US 20150112496 consists of a volt-var control (VVC), wherein the voltage is controlled by the voltage regulator through a table that is updated in real time by remote command based on the power flow calculation that generates the optimal setpoints and the var control is done by at least one DER controlled locally by an algorithm for reactive injection, adjustment of active power injection, adjustment of power factor or voltage level. It is applicable to an energy distribution network occupying a large geographical area. However, it does not work without the supervision of a central system, connected through a telecommunications system, and with the knowledge of the entire distribution network of interest.

Thus, we conclude from the researched prior art that no prior art was found anticipating or suggesting the techniques of the present invention, so that the solution proposed herein has novelty and inventive step over the prior art.

### SUMMARY OF INVENTION

In view of the limitations found in the prior art, it is necessary to develop a new technique capable of controlling several points in the branched distribution network through a single Voltage Regulator bank, whether with one Regulator per phase or even with two Regulators for the three phases, R, S and T in the case of open delta configurations.

In a first aspect the present invention describes a voltage controller device comprising:
a. Means for remote communication with the meters and/or with an intermediate point that has already collected the information;
b. Means for performing a method for determining the optimized operating point or optimized TAP for operation of the Voltage Regulator or the Voltage Regulators bank; and
c. Means for communication with the controller of the Voltage Regulator.

In a preferred embodiment, the means for remote communication include LPWA communication and/or mesh network.

In a further preferred embodiment, the device further comprises means for learning and memorizing the impact of voltage changes at each point of the branched network.

In another preferred embodiment, the device comprises a digital to analog converter (DAC) and/or an analog signal converter and conditioner (AFE).

In a second aspect, the present invention describes a method for determining the optimized operating point or optimized TAP comprising the steps of:
a. Obtaining the data from the meters;
b. Calculation of the voltage regulation range;
c. Calculation of the weighted average voltage for the sensors;
d. Calculation with prediction of the number of Taps to be switched; and
e. Verifying that the voltages are within the voltage regulation range.

In a preferred embodiment, the method further comprises an additional step of excluding the values of meters with very discrepant readings compared to the others between steps a) and b).

In a preferred embodiment, the method further comprises an additional step of excluding a point with a value outside the voltage regulation range and optionally sending an alarm to SCADA, between steps a) and b).

In a preferred embodiment, the method further comprises an additional step of changing the direction of the Tap if the voltage variations are not in the expected direction of those from the expected voltage regulation, between steps d) and e).

In a preferred embodiment, the method further comprises the steps of: memorizing the impact of the changes at each point of the network by continuously updating the prediction calculations optionally using artificial intelligence or machine learning, performed between steps a) and e), and using this information in calculating the weighted average voltage for determining the optimized point for the various controlled points. The prediction is part of the calculation algorithm where it predicts the voltages in advance, based on the coefficients continuously updated by the artificial intelligence that monitors all the voltages involved and how their Delta V variations are related, thus avoiding destabilization in the voltage control.

In a third aspect, the present invention describes a branched network voltage control system comprising:
a. Voltage controller device comprising means for determining the optimized operating point;
b. Plurality of field meters;
c. Means for sending the information from the meters to the voltage controller device; and
d. Voltage regulator,
wherein the control and measurement system is independent from the SCADA system, comprising an autonomous measurement and control system with an actuation radius of up to 15 km, different from Smart Grid systems that normally require communication integrated with the SCADA and various control devices in a vast geographic field of several tens or hundreds of kilometers in radius.

### BRIEF DESCRIPTION OF THE FIGURES

FIG. 1 shows a hypothetical diagram of the branched electrical power distribution network.

FIG. 2 shows a hypothetical diagram of the branched electrical power distribution network with loads on both sides of the Voltage Regulator.

FIGS. 3A and 3B show the limits of a Reference Voltage (TR) plus the upper and lower variations accepted for the adequate voltage range (ΔADSUP and ΔADINF).

FIG. 4 shows a block diagram for an embodiment of the voltage controller device.

FIG. 5 shows a preferred embodiment of the method for determining the optimized operating point or optimized TAP.

FIG. 6 presents the result of a simplified theoretical study.

FIG. 7 presents a general diagram of the control and communication system.

### DETAILED DESCRIPTION OF THE INVENTION

The following descriptions are presented by way of example and are not limiting to the scope of the invention, in order to allow a clearer understanding of the subject matter of the present patent application.

The voltage controller device of the present invention is the module that controls the entire system. It receives the readings of the points to have their voltage controlled through the LPWA radio modem, runs the control algorithm and sends the control voltage to the controller of the voltage regulator bank. An example of its block diagram is presented in FIG. 4. In addition to the branch with the physical layer of the communication interface, the protocol stack and the application layer from the controller to the controller's communication port, it also has a branch with the method for determining the optimized operating point or optimized TAP (voltage control algorithm), digital to analog conversion (DAC) and an output amplifier (AFE—Analog Front End) until the input of the TP of the controller of the Voltage Regulator. The input of the TP is what effectively activates the internal algorithms of the controller. This functionality determines an advantage of this invention, which is compatibility with equipment already installed in the field, that is, the field legacy. Within the Branched Network Voltage Controller, the main control activity is performed by the Specialist Voltage Control Algorithm.

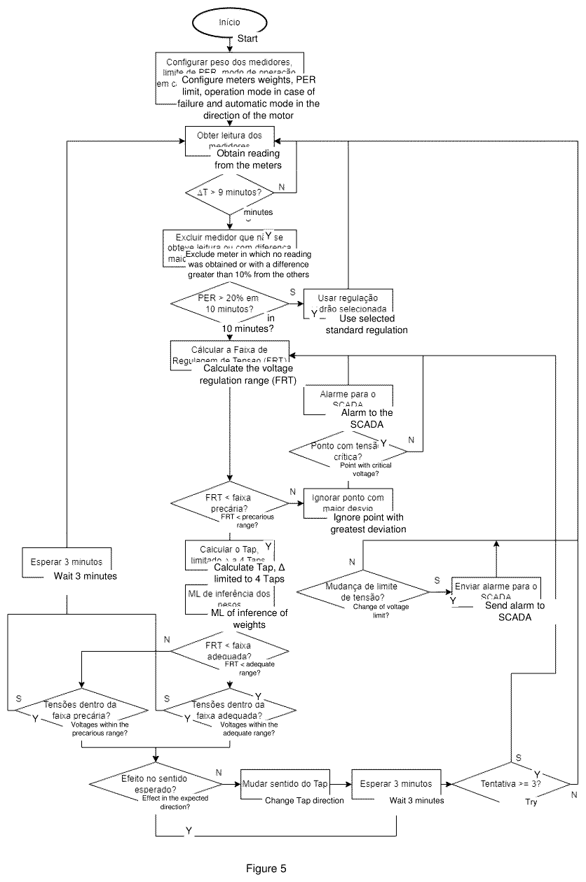

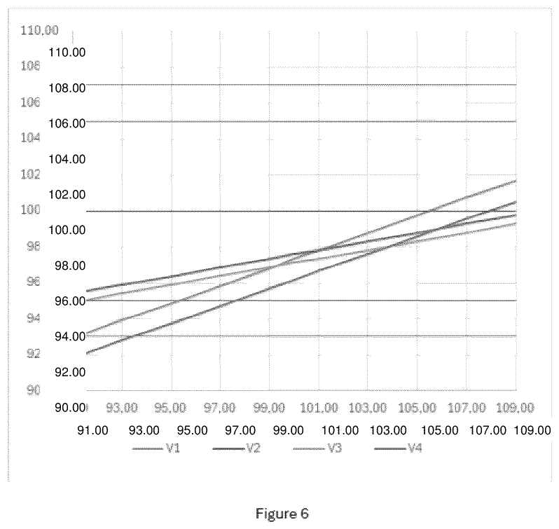

An embodiment of the Branched Network voltage control algorithm is illustrated in the flowchart of FIG. 5 and described below.

It consists first of all of obtaining the readings from the sensors within a time interval ΔT of 9 minutes or configurable. If a sensor reading is not obtained in this interval or this reading has a difference greater than 10% or configurable to the others, it will be discarded in this iteration.

If the PER (Packet Error Rate) of the LPWA system is greater than 20% or configurable within a 10-minute interval or configurable, the algorithm will be disabled and the default regulation selected by the user will be used.

The default regulation may be non-switch or common mode. The common mode is the operating algorithms already available in the traditional regulator controller of the prior art, such as locked in direct flow, bidirectional, neutral idle, cogeneration etc.

In any case, the protection limits of the regulator configured in the Voltage Regulator controller continue to take priority.

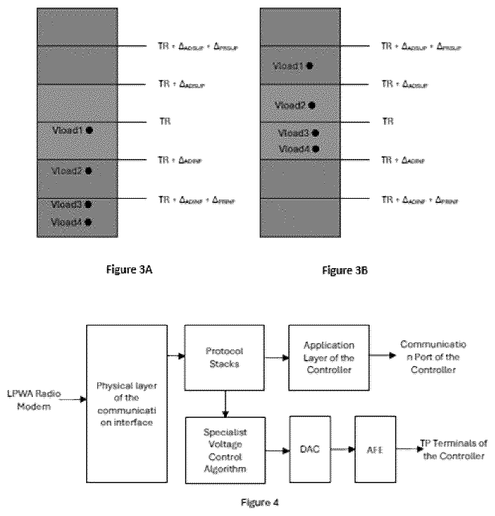

Initially, the variation between extreme measurements is calculated, it is called Voltage Regulation Range. Then, it is verified whether this variation is less than or equal to any of the ranges specified in Aneel's guidelines, in annex 8 of module 8 of Prodist, illustrated in FIGS. 3A-3B.

FIG. 3A presents the voltages that can be observed in the field in a branched distribution line in a hypothetical situation with a traditional voltage controller, which controls only one line, as in the example of FIG. 3A, load line 1. The voltages can and certainly will be out of bounds, since the control system does not effectively control the voltages of all legs. As shown in FIG. 3A, undervoltage is usually presented, in this example with loads 3 and 4 with critical voltage. FIG. 3B, in turn, presents the result obtained with the control system for branched distribution networks, wherein the objective of the control algorithm is to adjust the voltage regulator so that the voltages are in the best possible way within the limits of adequate voltage. In this example, the voltages were almost all in the adequate voltage range, only with the voltage of load 1 being in the precarious voltage range after the voltage elevation performed by the Voltage Regulator.

If the Voltage Regulation Range is less than the variation between the maximum and minimum limits of the precarious voltage range, then the Tap is calculated according to the procedure presented in the next paragraphs to regulate as many points as possible within the precarious voltage range. A tolerance in these limits must be considered, which is configurable, to avoid instability for the case of points very close to the limits. Otherwise, the point with the greatest deviation from the average is ignored and this logic is repeated. In this case, this point with greater deviation may be in the critical voltage range and, in this case, an alarm may optionally be sent to the SCADA system informing about it. This procedure of eliminating points must be repeated until only the points within the precarious voltage range are obtained.

If the Voltage Regulation Range is less than the variation between the maximum and minimum limits of the adequate voltage range, then the Tap is calculated according to the procedure presented in the next paragraphs to regulate all points within the adequate voltage range.

Every 3 minutes or configurable, the Tap that must be triggered in the Voltage Regulator is calculated, and the maximum amplitude of the change is 4 Taps. The objective is to minimize the number of times the tap is changed to maximize the lifespan of the changer. However, it must be fast enough that the voltage is regulated within 10 minutes of the integration time of the voltage adequacy verification specified by the regulation.

To calculate the Tap, the weighted average is calculated according to equation (1):

$$Sm = ( S 1 \times P 1 + Sn \times Pn ) / ( P 1 + Pn ) \qquad ( 1 )$$

where P1 is the weight of sensor 1 (S1), Pn is the weight of sensor N (Sn), and Sm is the average voltage of the sensors.

From this calculated average voltage, the traditional Tap calculation algorithm is used, that is, the calculation of the number of Taps to be switched is based on the difference between the average of the voltage measurement of the various legs and the nominal voltage. Based on prediction, the voltage of each branch is calculated before switching the Tap and if it indicates a better situation than the current one, the algorithm makes the decision to change the Tap.

Weights can be used to optimize the result. Initially the weight is 1 or configurable. If the customer wants to prioritize a sensor, it can have a higher weight, which can be an integer from 1 to 10. If the customer has an in-depth analysis of the feeder in question, they may sometimes be able to infer optimal values for the weights.

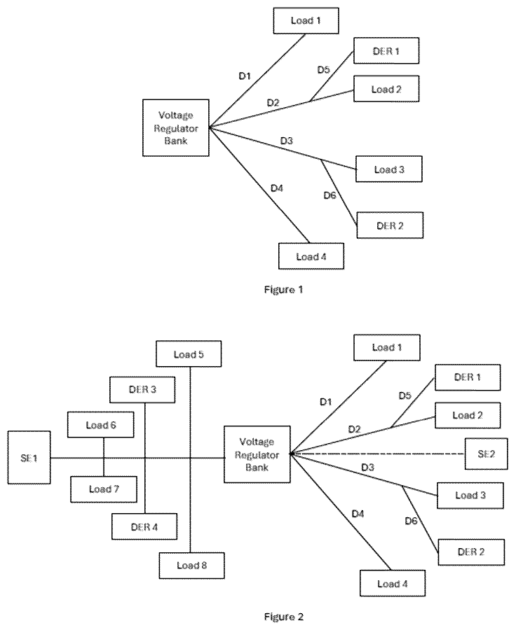

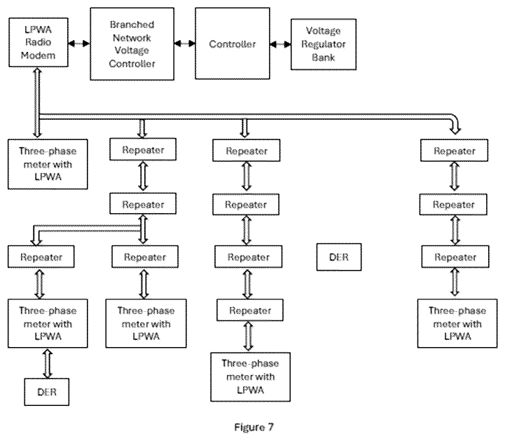

Optionally the weights can be refined by machine learning by reading the sensors and verifying the best adaptation to the limits. This is especially useful when the DER is present in some legs and affects the response of these legs in relation to the voltage adjusted by the Voltage Regulator, causing its variation at a rate different from the rate of variation of the legs without DER. For instance, FIG. 6 presents the result of a simplified theoretical study just to illustrate and contextualize the problem. It presents the hypothesis of the DER of FIG. 1 being in voltage control mode using reactive injection. In this mode, the DER will regulate the voltage of its load a little, limited to its power capacity, not responding with the same rate of variation as V1 and V4 to the voltage adjusted by the Voltage Regulator, as shown in lines V2 and V3. However, the trend of evolution of voltages from V1 to V4 can be quickly inferred by Machine Learning in a few iterations. Only prior training is required in similar scenarios. Adequate learning techniques for this case are error correction learning and memory learning. During the operation, the learning can be refined using the incremental learning technique. As a result of this inference, the values of the weights of each voltage will be determined to allow for an optimal adjustment.

After changing the Tap, it is verified that all voltages are within the precarious or adequate voltage range, as the case may be, in three attempts at most.

If after three attempts the points are not all within the precarious or adequate voltage range, as the case may be, go back to the step of calculating the Voltage Regulation Range. In addition, it may also be necessary to eliminate one more point and optionally send the respective alarm to the SCADA system in the case of precarious voltage range, if this point is in the critical voltage range.

The Algorithm analyzes the direction of change of the motor. This mode detects the general voltage change direction and reverses the motor drive direction if it is not the correct direction for line regulation. This may be required to fit the scenario described in FIG. 2, where the strong side of the Voltage Regulator can change according to the situation.

Optionally, a message is sent to the SCADA system if there is a change in voltage range, according to the limits of the FIGS. 3A-3B (critical, precarious or adequate voltage).

It is possible for the user to configure the weight of each sensor, the PER limit of the system, the operation mode in case of failure, which may be non-switch or common mode and enable or disable the automatic mode of motor direction.

It is possible to monitor the state of the sensors and their weights, the voltage at each sensor and PER of each sensor.

In addition to the control through the voltage applied to the controller's TP input, the application layer communication protocol also has voltage control commands that trigger the controller. However, this functionality is only operational with compatible controllers.

LPWA Radio Modem—It is the central data collector of the communication network. An example of LPWA communication that can be used is the Wi-SUN standard, which uses the TCP/IPv6 protocol and transparently transports application data. In addition, it is able to form a mesh network through its 6lowpan layer. This characteristic is fundamental to reach the long distances involved in energy distribution. The Wi-SUN has a reach of a few kilometers in the open field, but the distances from the distribution lines can reach dozens of kilometers. In addition, mountainous terrain and obstacles of the urban area limit this reach. All this makes a mechanism such as the mesh network mandatory to afford the necessary reach.

LPWA Repeater—These are the elements placed along the distribution line, in strategic locations, to route the signal from the voltage sensors to the LPWA radio modem.

Three-phase Voltage or Energy Meter with internal LPWA Transponder—It is the voltage sensor that collects the signal to be processed, necessary for the voltage regulation algorithm in the branched network. It can be an energy meter that still has the ability to send additional information to the Branched Network Voltage Controller.

FIG. 7 presents a general diagram of the control and communication system. It presents the three-phase meters with LPWA module collecting the data at the voltage control points and transmitting them over a long distance through the repeaters. At the points where the sensors are present, there may be Distributed Energy Resources (DER), which optionally allows the collection of additional information about the injected energy that can be used in the Branched Network Voltage Controller for other future applications. DER affects the voltage of the branched distribution network, but it is not possible for this system to obtain any information about it other than its indirect effect on the voltage behavior in the various sensors in the network. The data is collected from the meters and repeaters by the LPWA Radio Modem, transferred to the Branched Network Voltage Controller, which calculates the control voltage to be sent to the controller, which in turn passes the commands to the Tap-changer of the Voltage Regulator Bank.

The invention described herein features the following novel features:

The use of a voltage for the interface with the controller of the voltage regulator is an innovation that allows compatibility with legacy equipment installed in the field. That is, the Voltage Regulation System in Branched Networks can be installed in a complementary way in Voltage Regulators already installed in the field.

The characteristics inherent to the topology of the branched distribution network can be inferred by the control algorithm from the feedback of the voltages obtained at the points with meters installed in response to the control command sent, through the intrinsic black box treatment of the described algorithm. This can be done without the need to know or program in the Branched Network Voltage Controller the network parameters, usually available only in the GIS (Geographic Information System) of the distributor.

It is also possible to send digital commands to Voltage Regulator Controllers compatible with the system. This allows for greater accuracy in the control, as it is immune to the noises inherent to the analog signals that occur in the control using a reference voltage.

It collects readings from remote points of the branched distribution network using a dedicated LPWA constrained resource communication network with the ability to form mesh networks to bypass obstacles and supply the required long reach.

### EXAMPLES

The first preferred embodiment is the voltage control using the voltage input of the TP of the controller of the Voltage Regulator by supplying a control analog voltage through the Branched Network Voltage Controller that is part of a voltage control system comprising meters to obtain the voltage at the points of interest and telecommunications to distribute this information to the controller. This method allows compatibility with the legacy installed in the field.

The second preferred embodiment is similar to the first, with the difference that the voltage control is done using the application protocol of the Branched Network Voltage Controller. For this, it is necessary to use a Voltage Regulator controller compatible with this protocol. The advantage in this case is the greater control precision, as no command bit is lost.

The third preferred embodiment is the Branched Network Voltage Controller equipment itself. It comprises, as presented in FIG. 4, a physical layer to interface with the communication, the protocol stack in the software, the specialist voltage control algorithm also in its software, a DAC (Digital to Analog converter) and AFE (Analog Front End) to convert the binary signal into an analog signal to act on the TP terminals of the controller of the voltage regulator and also the application layer of the communication with the voltage regulator controller for this same purpose.

The fourth preferred embodiment is the specialist voltage control algorithm in branched networks itself. It can be embedded in a voltage regulator controller and consists in the algorithm described herein.

1. A voltage controller device, comprising:
a. Means for remote communication with meters and/or with an intermediate point that has already collected information;
b. Means for performing a method for determining an optimized operating point or an optimized TAP for operation of a Voltage Regulator or a Voltage Regulators bank; and
c. Means for communication with a controller of the Voltage Regulator.

2. The voltage controller device according to claim 1, wherein the means for remote communication comprise LPWA communication and/or mesh network.

3. The voltage controller device according to claim 1, further comprising means for learning and memorizing an impact of voltage changes at each point of a network.

4. The voltage controller device according to claim 1, further comprising a digital to analog converter (DAC) and/or an analog signal converter and conditioner (AFE).

5. A method for determining an optimized operating point or an optimized TAP, comprising steps of:
a. Obtaining data from meters;
b. Calculation of a voltage regulation range;
c. Calculation of a weighted average voltage for sensors;
d. Calculation of a number of Taps to be switched; and
e. Verifying that the voltages are within the voltage regulation range.

6. The method of claim 5, further comprising an additional step of excluding values of meters with very discrepant readings compared to others between steps a) and b).

7. The method of claim 5, further comprising an additional step of excluding a point with a value outside the voltage regulation range and sending an alarm to SCADA, between steps a) and b).

8. The method of claim 5, further comprising an additional step of changing a direction of the Tap if voltage variations are not in an expected direction of those from an expected voltage regulation, between steps d) and e).

9. The method of claim 5, further comprising the steps of: memorizing an impact of changes at each point of a network by means of artificial intelligence or machine learning, performed between steps a) and e), and using this information in calculating the weighted average voltage for the sensors.

10. A branched network voltage control system, comprising:
a. A voltage controller device comprising means for determining an optimized operating point;
b. A plurality of field meters;
c. Means for sending information from the field meters to the voltage controller device; and
d. A voltage regulator,
wherein the control system is independent from a SCADA system, and further comprises an autonomous control system having an actuation radius of up to 15 km.
